(19) United States
(12) Patent Application Publication
(10) Pub. No.: US 2020/0238325 A1
(43) Pub. Date: Jul. 30, 2020

(54) COATING DEVICE

(71) Applicant: HONDA MOTOR CO., LTD., MINATO-KU, TOKYO (JP)

(72) Inventors: Takashi YAMAMURO, HAGAGUN, TOCHIGI (JP); Hirofumi MIMA, HAGAGUN, TOCHIGI (JP); Masaaki SHOJI, HAGAGUN, TOCHIGI (JP)

(21) Appl. No.: 16/651,170

(22) PCT Filed: Sep. 28, 2018
(86) PCT No.: PCT/JP2018/036483

§ 371 Date: Mar. 26, 2020

(30) Foreign Application Priority Data
Sep. 29, 2017 (JP) 2017-190286

(51) Int. Cl. B05B 15/18; B05B 3/10

(52) U.S. Cl. CPC B05B 15/18; B05B 3/1014

(57) ABSTRACT

A coating device includes: a rotating shaft; outer members; and an inner member connected to at least one of the outer members. The inner member includes: a cylindrical body which is connected to at least one of the outer member and includes an annular opening continuing to a coating-material diffusion surface of the outer member; a disk-shaped lid which is provided on the inner side of the opening and has an outer peripheral edge part of a smaller diameter than the opening; and a supporting part which connects the lid and the body. A rear surface of the lid and an inner peripheral surface of the body form a coating-material reservoir. An annular slit is formed between the outer peripheral edge part of the lid and the opening. The supporting part is provided more inside in the radial direction than the slit when viewed along an axial line.

### TECHNICAL FIELD

The present invention relates to a coating device. More specifically, the present invention relates to a rotary atomizing type coating device in which a tubular outer member and an inner member provided inside the outer member are rotated with a rotating shaft to atomize a liquid coating using centrifugal force, thereby forming a coating film on a surface to be coated.

### BACKGROUND ART

A rotary atomizing type coating device is widely used as a coating device for applying a coating to an object to be coated such as a body or panel of an automobile. In the rotary atomizing type coating device, a tubular rotary atomizing head, more specifically, a bell-shaped rotary atomizing head is rotated at a high speed, whereby a liquid coating is atomized on an inner peripheral face of the rotary atomizing head utilizing centrifugal force, and a coating film is formed on a surface to be coated. In many cases, the rotary atomizing head is, for example, a combination of a bell-shaped outer member attached to a rotating shaft and an inner member provided inside the outer member and supplying a coating supplied from a rotating shaft side to a coating diffusion face which is an inner peripheral face of the outer member. Further, as for the inner member, a tubular member, in which a lid portion is provided on the front face side, which is the side of the surface to be coated, and a plurality of through holes for guiding the coating supplied from the rear face side to the coating diffusion face is formed on the side, is used (for example, refer to Patent Documents 1 and 2).

Patent Document 1: Japanese Unexamined Patent Application, Publication No. H09-234393

Patent Document 2: Japanese Unexamined Patent Application, Publication No. 2016-36771

### DISCLOSURE OF THE INVENTION

### Problems to be Solved by the Invention

Incidentally, the surface of the inner member is worn with use at a speed corresponding to the use conditions (e.g., the material of the coating, the discharge amount of the coating, the rotation speed of the rotary atomizing head, and the like) of the coating device, the material of the inner member, and the like. Especially, if a bright pigment such as mica or alumina having high hardness is used for the coating, wear rapidly progresses. Among the flow paths of the coating formed in the inner member, wear around the through hole near the coating diffusion face is severe.

If the use is continued in a state where wear progresses excessively, the quality of the coating film formed on the surface to be coated is deteriorated, and therefore, it is necessary to replace the inner member at an appropriate timing. However, since it takes cost and time to replace the inner member, it is preferable that the life of the inner member is as long as possible so that the replacement frequency can be minimized.

It is an object of the present invention to provide a rotary atomizing type coating device capable of reducing the replacement frequency of the inner member. Means for Solving the Problems

(1) A coating device (e.g., the coating device 1, 1A described later) of the present invention includes a rotating shaft (e.g., the rotating shaft 24 described later), a tubular outer member (e.g., the outer member 4 described later) connected to a leading end side of the rotating shaft, and an inner member (e.g., the inner member 5 described later) connected to at least one of the rotating shaft and the outer member inside the outer member. The inner member includes a tubular body portion (e.g., the body portion 6 described later) connected to at least one of the rotating shaft and the outer member and including an annular opening portion (e.g., the opening portion 62 described later) continuous with a coating diffusion face (e.g., the coating diffusion face 46 described later) which is an inner peripheral face of the outer member, a disk-shaped lid portion (e.g., the lid portion 71 described later) provided inside the opening portion and including an outer peripheral edge portion (e.g., the outer peripheral edge portion 72 described later) having a diameter smaller than that of the opening portion, and a support portion (e.g., the support portion 75 described later) connecting the lid portion to the body portion. A coating reservoir portion (e.g., the coating reservoir portion 8 described later), which is a space where a coating supplied from a rotating shaft side accumulates, is formed by a face (e.g., the rear face 73a described later) on the rotating shaft side of the lid portion and an inner peripheral face (e.g., the inner peripheral face 63 described later) of the body portion. An annular slit (e.g., the slit 9 described later) guiding the coating in the coating reservoir portion to the coating diffusion face is formed between the outer peripheral edge portion of the lid portion and the opening portion. The support portion is provided radially inward of the slit as viewed along an axial direction.

(2) In this instance, it is preferable that the lid portion and the support portion are an integral member (e.g., the hub member 7, 7A described later), the body portion is a member separate from the lid portion and the support portion, the support portion includes a cylindrical coupling portion (e.g., the coupling portion 76 described later) connected to the body portion and a plurality of support pillar portions (e.g., the support pillar portions 77a, 77b, 77c, 78a, 78b, 78c described later) extending along the axial direction and connecting the coupling portion to the lid portion, and the coupling portion is provided closer to the rotational axis than the slit along the axial direction.

(3) In this instance, it is preferable that the opening portion is formed on a leading end side of the body portion, an annular base end portion (e.g., the base end portion 65 described later) extending along a face perpendicular to the rotating shaft is formed on a base end side of the body portion, a plurality of tool holes (e.g., the tool holes 67, 67 described later) is formed on the rotating shaft side of the base end portion, and the coupling portion is connected to an inner peripheral face (e.g., the connection face 66 described later) of the base end portion.

### Effects of the Invention

(1) The coating device includes the outer member connected to the leading end side of the rotating shaft, and the inner member provided inside the outer member. The inner member includes the body portion including the opening portion continuous with the coating diffusion face of the outer member, the lid portion including the outer peripheral edge portion having a diameter smaller than that of the opening portion, and the support portion connecting the body portion to the lid portion. In the inner member, the coating reservoir portion is formed by the face on the rotating shaft side of the lid portion and the inner peripheral face of the body portion, and the annular slit is formed between the outer peripheral edge portion of the lid portion and the opening portion of the body portion. Therefore, according to the coating device of the present invention, when a coating is supplied from a coating nozzle on the rotating shaft side to the coating reservoir portion while the outer member and the inner member are rotated with the rotating shaft, the coating in the coating reservoir portion is accelerated toward the slit disposed radially outside by centrifugal force, guided to the coating diffusion face through the slit, and made into a thin film and atomized on the coating diffusion face, and a coating film is formed on a surface to be coated provided on the front face side of the outer member. In particular, in the present invention, the support portion connecting the lid portion forming the slit to the body portion is provided radially inward of the slit as viewed along an axial direction. Therefore, since the coating in the coating reservoir portion before being sufficiently accelerated from an axis side toward the slit collides with the support portion, it is possible to suppress wear as compared with the case where the support portion is provided in the slit. As described above, according to the coating device of the present invention, it is possible to suppress wear of the support portion, which is a portion where wear has conventionally been severe, and consequently, it is possible to reduce the replacement frequency of the inner member.

(2) In the coating device of the present invention, the lid portion and the support portion are formed as an integral member, and the body portion and the lid portion (including the support portion) are formed as separate members, whereby the machining of the body portion and the lid portion can be facilitated. Further, by forming these portions as separate members, it is possible to disassemble and clean or maintain the body portion and the lid portion, and further, it is possible to replace only the lid portion or only the body portion. It should be noted that if the body portion, and the lid portion and the support portion, are formed as separate members as described above, when the support portion is worn by use, the lid portion may be displaced with respect to the body portion, and the quality of the coating film may be deteriorated. On the other hand, in the coating device of the present invention, the support portion is constituted by a cylindrical coupling portion connected to the body portion and a plurality of support pillar portions extending along an axial direction and connecting the coupling portion to the lid portion, and further, the coupling portion is provided closer to the rotating shaft than the slit along an axial direction. By providing the coupling portion closer to the rotating shaft than the slit in this manner, the coating before being sufficiently accelerated flows through the coupling portion, and therefore, it is possible to suppress wear of the coupling portion. Therefore, according to the present invention, the disadvantage due to forming the body portion, and the lid portion and the support portion, as separate members does not appear.

(3) In the coating device of the present invention, the annular base end portion extending along a face perpendicular to the rotating shaft is provided on the base end side of the body portion. A plurality of tool holes is formed on the rotating shaft side of the base end portion which is the opposite side of the opening portion. According to the coating device of the present invention, by forming the tool holes at such positions, it is possible to easily apply force to a tool when detaching the inner member from the outer member. In the coating device of the present invention, by connecting the coupling portion, which connects the body portion to the lid portion, to the inner peripheral face of the base end portion, it is possible to dispose the coupling portion and a plurality of support pillar portions extending from the coupling portion along an axial direction radially inward so as to approach the axis. Thus, it is possible to further suppress wear of the coupling portion and the support pillar portions.

### BRIEF DESCRIPTION OF THE DRAWINGS

FIG. 1 is a cross-sectional view showing the configuration of a coating device according to a first embodiment of the present invention;

FIG. 2 is a cross-sectional view of an inner member;

FIG. 3 is a perspective view showing the configuration of a body portion which is a component of the inner member;

FIG. 4 is a perspective view showing the configuration of a hub member which is a component of the inner member;

FIG. 5 is a cross-sectional view taken along line A-A of FIG. 4; and

FIG. 6 is a cross-sectional view of a hub member of a coating device according to a second embodiment of the present invention.

### PREFERRED MODE FOR CARRYING OUT THE INVENTION

### First Embodiment

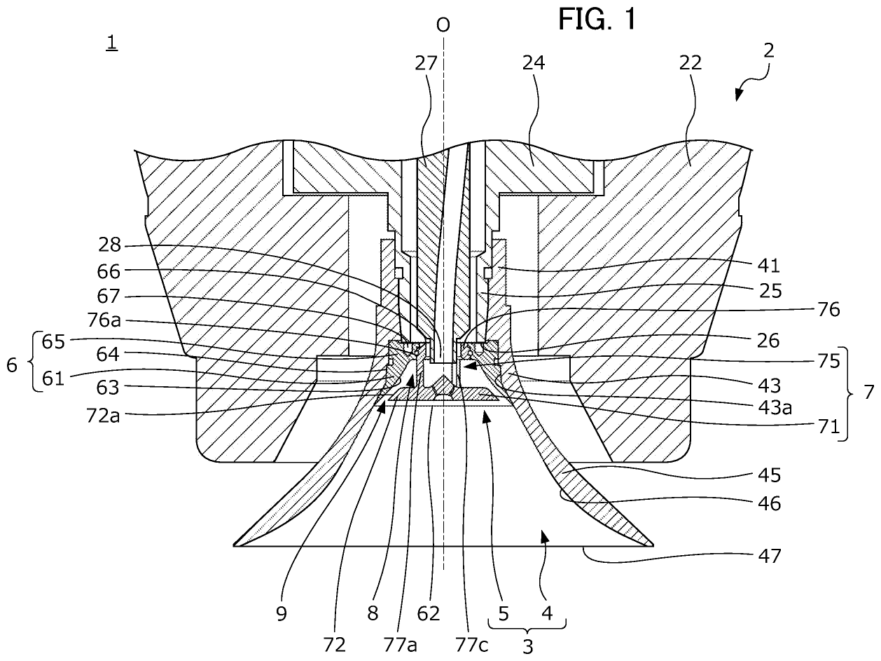

Hereinafter, a first embodiment of the present invention will be described with reference to the drawings. FIG. 1 is a cross-sectional view showing the configuration of a coating device 1 according to the present embodiment. The coating device 1 is a so-called rotary atomizing type device which supplies a liquid coating to the interior of a rotary atomizing head 3 while rotating the rotary atomizing head 3 with a rotating shaft 24, and makes the coating into a thin film and atomizes the film in the rotary atomizing head 3 using centrifugal force, thereby forming a coating film on a coating surface of an object to be coated (not shown). The coating device 1 is attached to, for example, a leading end portion of a robot arm (not shown), and forms a coating film on a body of an automobile provided on the front face side of the rotary atomizing head 3.

The coating device 1 includes a rotating shaft 24, a device body 2 rotatably supporting the rotating shaft 24, and a cylindrical rotary atomizing head 3 provided on the leading end side of the rotating shaft 24.

The rotating shaft 24 is hollow and extends along an axis O. In the interior of the rotating shaft 24, a tubular feed tube 27 is provided for guiding a liquid coating or cleaning liquid to the interior of the rotary atomizing head 3. A leading end portion 28 of the feed tube 27 extends toward the front face side as compared with a leading end face 26 of the rotating shaft 24, and reaches the interior of the coating reservoir portion 8 described later, which is formed in the interior of the rotary atomizing head 3.

The device body 2 includes a rotating shaft 24, an air motor (not shown) rotating the rotating shaft 24, a supply device (not shown) supplying a liquid coating or cleaning liquid to the interior of the feed tube 27, and a housing 22 supporting the rotating shaft 24, the air motor, and so on.

The rotary atomizing head 3 is configured by combining a tubular outer member 4 with a tubular inner member 5 provided inside the outer member 4. The outer member 4 and the inner member 5 are separate members. The outer member 4 is produced from metal such as stainless steel, titanium, aluminum, or the like, but the present invention is not limited thereto. The inner member 5 is preferably produced from resin (specifically, for example, a PEEK (polyetheretherketone) resin) in view of the three-dimensional structure described below, but the present invention is not limited thereto. The inner member 5 may be produced from metal such as stainless steel, titanium, aluminum, or the like in consideration of its durability.

The outer member 4 has a tubular shape, more specifically, a bell shape that increases in diameter from a rotating shaft 24 side toward the front face side. The outer member 4 includes a cylindrical base end portion 41, a cylindrical accommodation portion 43 accommodating the inner member 5, and a bell-shaped diameter enlarging wall portion 45 in sequence from the rotating shaft 24 side to the front face side along the axis O.

The outer member 4 is fixed coaxially with the rotating shaft 24 by fitting the leading end portion 25 of the rotating shaft 24 into the interior of the base end portion 41 and further fixing the base end portion 41 and the leading end portion 25 with a fastening member (not shown) or the like. The accommodating portion 43 includes an inner peripheral face 43a having a shape along the outer shape of the inner member 5.

A coating diffusion face 46, which is the inner peripheral face of the diameter enlarging wall portion 45, has a tapered shape that enlarges in diameter from the annular slit 9 described later, which is formed in the inner member 5, toward an annular leading end edge 47 closest to the object to be coated. A plurality of grooves (not shown) extending along a radial direction is formed at equal intervals along a circumferential direction on the leading edge 47 side of the coating diffusion face 46 in order to make the coating filmily spreading on the coating diffusion face 46 into liquid yarn.

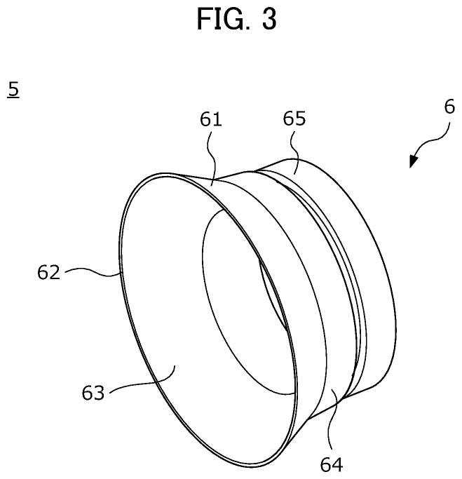

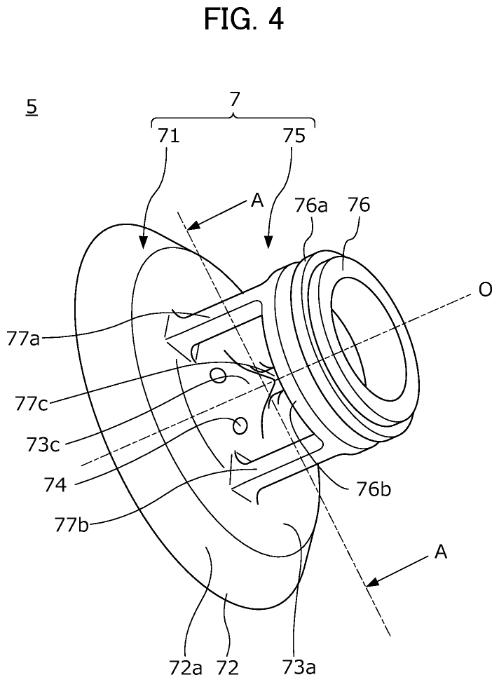

The inner member 5 is configured by combining a cylindrical body portion 6 with a hub member 7 provided inside the body portion 6. The body portion 6 and the hub member 7 are separate members and can be disassembled as shown in FIGS. 3 and 4.

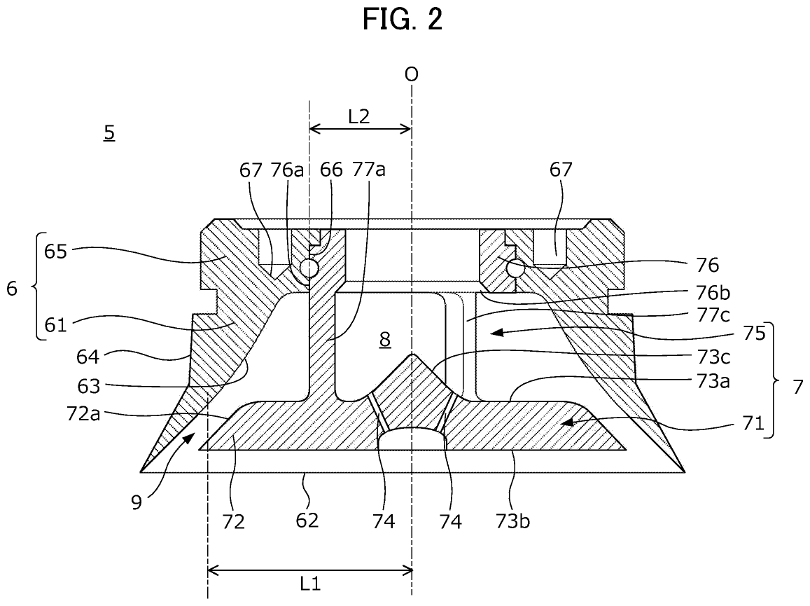

FIG. 2 is a cross-sectional view of the inner member 5. FIG. 3 is a perspective view showing the configuration of the body portion 6 which is a component of the inner member 5. FIG. 4 is a perspective view showing the configuration of the hub member 7 which is a component of the inner member 5.

The body portion 6 includes a tubular-shaped tubular portion 61 extending along the axis O, and a base end portion 65 provided on the rotating shaft 24 side of the tubular portion 61. The tubular portion 61 and the base end portion 65 are an integral member. The base end portion 65 has a disk shape extending along a face perpendicular to the axis O. A through hole is formed in the center of the base end portion 65 along the axis O, and the tubular inner peripheral face thereof is a connection face 66 connected to the hub member 7. A plurality of tool holes 67, 67 is formed on the face on the rotating shaft 24 side of the base end portion 65.

The tubular portion 61 has a tubular shape extending from the base end portion 65 toward the front face side along the axis O. The forwardmost face of the tubular portion 61 is an annular opening portion 62. As shown in FIG. 1, when the inner member 5 is attached to the outer member 4, the opening portion 62 is continuous with the coating diffusion face 46 of the outer member 4. An inner peripheral face 63 of the tubular portion 61 has a tapered shape that increases in diameter from the rotating shaft 24 side toward the opening portion 62. The outer peripheral face of the tubular portion 61 is a connection face 64 that contacts the inner peripheral face 43a of the outer member 4.

The hub member 7 includes a disk-shaped lid portion 71 provided inside the opening portion 62, and a support portion 75 connecting the lid portion 71 to the body portion 6. The lid portion 71 and the support portion 75 are an integral member.

The outer diameter of the outer peripheral edge portion 72 of the lid portion 71 is smaller than the inner diameter of the opening portion 62 of the body portion 6. A tapered face 72a that increases in diameter from the rotating shaft 24 side toward the front face side is formed in the outer peripheral edge portion 72. The tapered face 72a and the inner peripheral face 63 of the opening portion 62 are substantially parallel to each other. A gap is formed over the entire circumference between the tapered face 72a and the inner peripheral surface 63, and corresponds to an annular slit 9 guiding a coating in the coating reservoir portion 8 described later to the coating diffusion face 46.

The space formed by a rear face 73a, which is the face on the rotating shaft 24 side of the lid portion 71, and the inner peripheral face 63 of the body portion 6 corresponds to the coating reservoir portion 8 in which a coating supplied from the feed tube 27 along the axis O accumulates.

Through holes 74 penetrating from the rear face 73a to a front face 73b are formed in the lid portion 71. In the center of the rear face 73a, a conical face 73c guiding the coating in the coating reservoir portion 8 to the slit 9 is formed.

The support portion 75 includes a coupling portion 76 connected to the body portion 6, and a plurality of (e.g., three) support pillar portions 77a, 77b, and 77c extending along the axis O and connecting the coupling portion 76 to the lid portion 71.

The coupling portion 76 has a cylindrical shape coaxial with the axis O, and its outer peripheral face corresponds to a connection face 76a contacting the connection face 64 of the body portion 6. A distance L2 from the axis O to the connection face 76a along a radial direction is shorter than a distance L1 from the axis O to the slit 9 along a radial direction. In other words, the coupling portion 76 is provided radially inward of the slit 9 as viewed along the axis O. The coupling portion 76 is provided closer to the rotating shaft 24 than the slit 9 along the axis O.

Each of the support pillar portions 77a to 77c has a pillared shape extending in parallel with the axis O and connects an end portion 76b on the front face side of the coupling portion 76 to the rear face 73a of the lid portion 71.

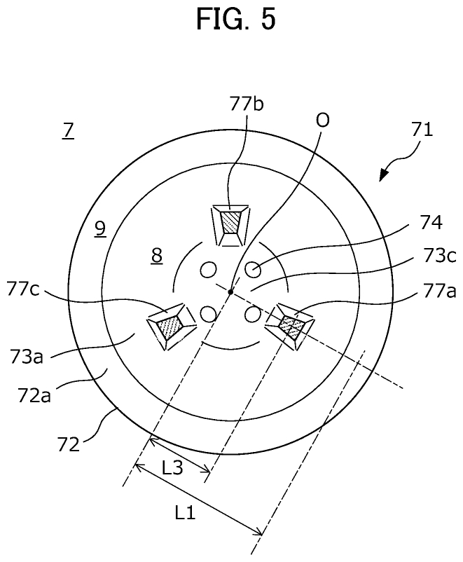

FIG. 5 is a cross-sectional view taken along line A-A in FIG. 4, more specifically, a cross-sectional view showing the cross sections of the support pillar portions 77a to 77c of the hub member 7 as viewed along the axis O. As shown in FIG. 5, the support pillar portions 77a to 77c are provided at equal intervals along a circumferential direction. A distance L3 from the axis O to the support pillar portions 77a to 77c along a radial direction is shorter than the distance L1 from the axis O to the slit 9 along a radial direction. In other words, the support pillar portions 77a to 77c are provided to penetrate through the interior of the coating reservoir portion 8 disposed radially inward of the slit 9 as viewed along the axis O.

The hub member 7 as described above is attached to the body portion 6 by pushing the coupling portion 76 into the tubular portion 61 of the body portion 6 and press-bonding the connection face 76a of the coupling portion 76 with the inner peripheral face 63 of the tubular portion 61. Further, the inner member 5 assembled with the body portion 6 and the hub member 7 as described above is attached to the outer member 4 by pushing the body portion 6 into the accommodation portion 43 of the outer member 4 and press-bonding the connection face 64 of the body portion 6 with the inner peripheral face 43a of the accommodation portion 43. Further, the inner member 5 attached to the outer member 4 as described above can be removed from the outer member 4 by fitting the tip section of a rod-shaped tool (not shown) into the tool holes 67, 67 and pushing the inner member 5 out to the front face side along the axis O.

(1) In the coating device 1, the support portion 75 connecting the lid portion 71 forming the slit 9 to the body portion 6 is provided radially inward of the slit 9 as viewed along the axis O. Therefore, since the coating in the coating reservoir portion 8 before being sufficiently accelerated from the axis O side toward the slit 9 collides with the support pillar portions 77a to 77c in the support portion 75, it is possible to suppress wear as compared with the case where the support pillar portions 77a to 77c are provided in the slit 9. As described above, according to the coating device 1, it is possible to suppress wear of the support pillar portions 77a to 77c, which have conventionally been severely worn, and consequently, it is possible to reduce the replacement frequency of the inner member 5.

(2) In the coating device 1, the lid portion 71 and the support portion 75 are formed as the integral hub member 7, and the body portion 6 and the hub member 7 are formed as separate members, whereby the machining of the body portion 6 and the hub member 7 can be facilitated. In addition, by forming these as separate members, the body portion 6 and the hub member 7 can be disassembled for cleaning or maintenance, and further, only the hub member 7 or only the body portion 6 can be replaced. It should be noted that if the body portion 6 and the hub member 7 are formed as separate members as described above, when the support portion 75 of the hub member 7 is worn by use, the lid portion 71 may be displaced with respect to the body portion 6, leading to deterioration in the quality of the coating film. In contrast, in the coating device 1, the support portion 75 is composed of a cylindrical coupling portion 76 connected to the body portion 6 and a plurality of the supporting pillar portions 77a to 77c extending along the axis O and connecting the coupling portion 76 to the lid portion 71, and further, the coupling portion 76 is provided closer to the rotating shaft 24 than the slit 9 along the axis O. By providing the coupling portion 76 closer to the rotating shaft 24 than the slit 9 in this manner, the coating before being sufficiently accelerated flows through the coupling portion 76, and therefore, it is possible to suppress wear of the coupling portion 76. Therefore, according to the coating device 1, the disadvantage due to forming the body portion 6 and the hub member 7 as separate members does not appear.

(3) In the coating device 1, an annular base end portion 65 extending along a face perpendicular to the rotating shaft 24 is provided on the base end side of the body portion 6. A plurality of the tool holes 67, 67 is formed on the rotating shaft 24 side of the base end portion 65 which is the opposite side of the opening portion 62. According to the coating device 1, by forming the tool holes 67, 67 at such positions, it is possible to easily apply force to a tool when detaching the inner member 5 from the outer member 4. Further, according to the coating device 1, by connecting the coupling portion 76, which connects the body portion 6 to the hub member 7, to the connection face 66, which is the inner peripheral face of the base end portion 65, it is possible to dispose the coupling portion 76 and the plurality of the support pillar portions 77a to 77c extending from the coupling portion 76 along the axis O radially inward so as to approach the axis O. Thus, it is possible to further suppress wear of the coupling portion 76 and the support pillar portions 77a to 77c.

### Second Embodiment

Next, a coating device 1A according to a second embodiment of the present invention will be described referring to the drawings. The coating device 1A according to the present embodiment differs from the coating device 1 according to the first embodiment in the configuration of the hub member 7A. In the following description, the same components as those of the first embodiment are denoted by the same reference numerals, and illustration and detailed description thereof are omitted.

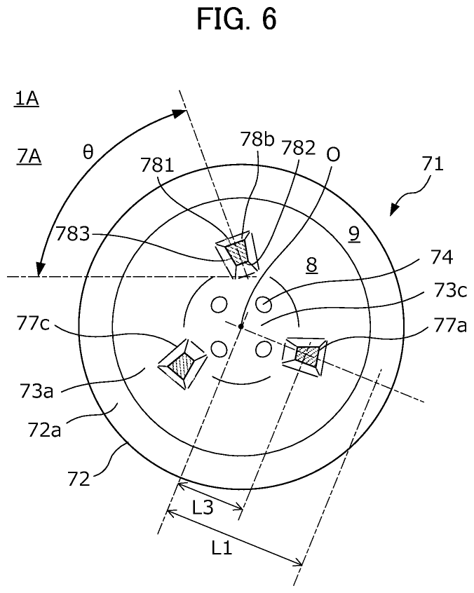

FIG. 6 is a cross-sectional view showing the configuration of a hub member 7A used in the coating device 1A according to the present embodiment. The hub member 7A differs from the hub member 7 according to the first embodiment shown in FIG. 5 in the configuration of the support pillar portions 78a, 78b, and 78c.

The support pillar portions 78a to 78c each have a pillared shape extending along the axis O and are provided at equal intervals along a circumferential direction. A distance L3 from the axis O to the support pillar portions 78a to 78c along a radial direction is shorter than the distance L1 from the axis O to the slit 9 along a radial direction. That is, the support pillar portions 78a to 78c are provided so as to penetrate through the interior of the coating reservoir portion 8 disposed radially inward of the slit 9 as viewed along the axis O.

The support pillar portions 78a to 78c have a substantially isosceles trapezoidal shape in a cross-sectional view perpendicular to the axis O. The lengths of a long side 781 and a short side 782 that are substantially parallel to each other in the cross-sectional view in the support pillar portions 78a to 78c are shorter than the length of a leg 783. The angle θ formed by the leg 783 and a tangent is set to between 0 and 90 degrees.

Since the coating in the coating reservoir portion 8 flows while swirling from the axis O side toward the slit 9 disposed radially outside, the angle θ formed by the leg 783 and the tangent is preferably set to between 40 and 80 degrees so that the flow of the coating is not obstructed by the support pillar portions 78a to 78c. For example, the results of the simulation performed by the present inventors revealed that the direction of flow of the coating is angled by 10 to 20 degrees with respect to a radial direction at the positions where the support pillar portions 78a to 78c are provided. Therefore, the angle θ formed by the leg 783 and the tangent is most preferably set to between 70 and 80 degrees.

According to the coating device 1A of the present embodiment, the following effect is achieved in addition to the effects (1) to (3) described above.

(4) According to the coating device 1A, the support pillar portions 78a to 78c have a substantially isosceles trapezoidal shape in a cross-sectional view perpendicular to the axis O, and the angle θ formed by the leg 783 and the tangent is set to between 40 and 80 degrees, more preferably between 70 and 80 degrees, thereby making it possible to make the coating flow along the surface of the leg 783, in other words, to make the impact angle of the coating with respect to the leg 783 approximately 0 degrees. Therefore, it is possible to suppress the projected area in the flow direction of the coating while securing the cross-sectional areas of the support pillar portions 78a to 78c, and therefore, it is possible to further suppress wear of the support pillar portions 78a to 78c.

Embodiments of the present invention have been described above; however, the present invention is not limited to the embodiments. The configuration of the details may be changed as appropriate within the spirit of the present invention.

### EXPLANATION OF REFERENCE NUMERALS

1, 1A Coating device

24 Rotating shaft

3 Rotary atomizing head

4 Outer member

46 Coating diffusion face

5 Inner member

6 Body portion

62 Opening portion

63 Inner peripheral face

65 Base end portion

67, 67 Tool hole

7, 7A Hub member (integral member)

71 Lid portion

72 Outer peripheral edge portion

75 Support portion

76 Coupling portion

77a, 77b, 77c, 78a, 78b, 78c Support pillar portion

8 Coating reservoir portion

9 Slit

1. A coating device comprising: a rotating shaft; a tubular outer member connected to a leading end side of the rotating shaft; and an inner member connected to at least one of the rotating shaft and the outer member inside the outer member,
wherein the inner member comprises: a tubular body portion connected to at least one of the rotating shaft and the outer member and including an annular opening portion continuous with a coating diffusion face which is an inner peripheral face of the outer member; a disk-shaped lid portion provided inside the opening portion and including an outer peripheral edge portion having a diameter smaller than that of the opening portion; and a support portion connecting the lid portion to the body portion,
a coating reservoir portion, which is a space where a coating supplied from a rotating shaft side accumulates, is formed by a face on the rotating shaft side of the lid portion and an inner peripheral face of the body portion,
an annular slit guiding the coating in the coating reservoir portion to the coating diffusion face is formed between the outer peripheral edge portion of the lid portion and the opening portion, and
the support portion is provided radially inward of the slit as viewed along an axial direction.

2. The coating device according to claim 1,
wherein the lid portion and the support portion are an integral member,
the body portion is a member separate from the lid portion and the support portion,
the support portion comprises: a cylindrical coupling portion connected to the body portion; and a plurality of support pillar portions extending along the axial direction and connecting the coupling portion to the lid portion, and
the coupling portion is provided closer to the rotational axis than the slit along the axial direction.

3. The coating device according to claim 2,
wherein the opening portion is formed on a leading end side of the body portion,
an annular base end portion extending along a face perpendicular to the rotating shaft is formed on a base end side of the body portion,
a plurality of tool holes is formed on the rotating shaft side of the base end portion, and
the coupling portion is connected to an inner peripheral face of the base end portion.
